(19) United States
(12) Patent Application Publication
(10) Pub. No.: US 2021/0084298 A1
(43) Pub. Date: Mar. 18, 2021

(54) METHOD AND APPARATUS FOR BOUNDARY PARTITION

(71) Applicant: HUAWEI TECHNOLOGIES CO., LTD., Shenzhen (CN)

(72) Inventors: Han Gao, Munich (DE); Semih Esenlik, Munich (DE); Zhijie Zhao, Munich (DE); Anand Meher Kotra, Munich (DE); Jianle Chen, Santa Clara, CA (US)

(21) Appl. No.: 17/106,163

(22) Filed: Nov. 29, 2020

Related U.S. Application Data
(63) Continuation of application No. PCT/EP2019/064011, filed on May 29, 2019.
(60) Provisional application No. 62/678,242, filed on May 30, 2018.

(51) Int. Cl. H04N 19/119; H04N 19/70; H04N 19/169; H04N 19/176

(52) U.S. Cl. CPC H04N 19/119; H04N 19/176; H04N 19/1883; H04N 19/70

(57) ABSTRACT

A method for boundary partition of a current block of a picture is provided. The method includes that a decoder receives a bitstream, where the bitstream includes a partition indicator; parses the bitstream to obtain the partition indicator; determines whether the current block is to be split based on the partition indicator; determines whether the current block is a boundary block when the current block is not to be split; and performs a boundary partition on the current block when the current block is a boundary block. The partition indicator of a same partition syntax is used no matter whether the current block is a boundary block (isB) or a non-boundary block (noB), which is benefit to keep the continuity of context-adaptive binary arithmetic coding (CABAC) engine, thus it will lead to higher coding efficiency.

### CROSS-REFERENCE TO RELATED APPLICATIONS

This application is a continuation of International Application No. PCT/EP2019/064011, filed on May 29, 2019, which claims priority to U.S. Provisional Application No. 62/678,242, filed on May 30, 2018, The disclosures of the aforementioned applications are hereby incorporated by reference in their entireties.

### TECHNICAL FIELD

The present disclosure relates to the technical field of image and/or video coding and decoding, and in particular to methods and apparatuses for boundary partition.

### BACKGROUND

Digital video has been widely used since the introduction of DVD-discs. Before transmission the video is encoded and transmitted using a transmission medium. The viewer receives the video and uses a viewing device to decode and display the video. Over the years the quality of video has improved, for example, because of higher resolutions, color depths and frame rates. This has lead into larger data streams that are nowadays commonly transported over internet and mobile communication networks.

Higher resolution videos, however, typically require more bandwidth as they have more information. In order to reduce bandwidth requirements video coding standards involving compression of the video have been introduced. When the video is encoded the bandwidth requirements (or corresponding memory requirements in case of storage) are reduced. Often this reduction comes at the cost of quality. Thus, the video coding standards try to find a balance between bandwidth requirements and quality.

As video involves a sequence of images results may be achieved also by treating individual images better. Thus, some methods and technologies can be used both in video and individual or still image processing.

As there is a continuous need for improving quality and reducing bandwidth requirements, solutions that maintain the quality with reduced bandwidth requirements or improve the quality while maintaining the bandwidth requirement are continuously searched. Furthermore, sometimes compromises may be acceptable. For example, it may be acceptable to increase the bandwidth requirements if the quality improvement is significant.

The High Efficiency Video Coding (HEVC) is an example of a video coding standard that is commonly known to persons skilled in the art. In HEVC, a coding unit (CU) is split into prediction units (PU) or transform units (TUs). The Versatile Video Coding (VVC) next generation standard is the most recent joint video project of the ITU-T Video Coding Experts Group (VCEG) and the ISO/IEC Moving Picture Experts Group (MPEG) standardization organizations, working together in a partnership known as the Joint Video Exploration Team (JVET). VVC is also referred to as ITU-T H.266/Next Generation Video Coding (NGVC) standard. In VVC, it removes the concepts of multiple partition types, i.e. it removes the separation of the CU, PU and TU concepts except as needed for CUs that have a size too large for the maximum transform length, and supports more flexibility for CU partition shapes.

As the video creation and use have become more and more ubiquitous, video traffic is the biggest load on communication networks and driver for increasing data storage demands. Accordingly, one of the goals of most of the video coding standards is to improve coding efficiency compared to its predecessor without sacrificing picture quality.

### SUMMARY

Apparatuses and methods for boundary partition are disclosed. The apparatuses and methods use a boundary partition processing for improving coding efficiency. Boundary partition processing is also called picture boundary handling.

According to a first aspect of the disclosure, a method for boundary partition of a current block of a picture is provided. The method includes that a decoder receives a bitstream, where the bitstream includes a partition indicator; parses the bitstream to obtain the partition indicator; determines whether the partition indicator indicates that the current block is to be split; determines whether the current block is a boundary block when the partition indicator indicates that the current block is not to be split; and performs a boundary partition on the current block when the current block is a boundary block.

No matter whether the current block is a boundary block or a non-boundary block, the partition indicator of a same partition syntax is used, which is benefit to keep the continuity of context-adaptive binary arithmetic coding (CABAC) engine, or in other words, to avoid switching between different partition syntax for boundary and non-boundary blocks, and thus facilitates higher coding efficiency.

According to an example of the first aspect of the disclosure, whether the partition indicator indicates that the current block is to be split is determined according to a non-boundary block partition syntax.

According to another example of the first aspect of the disclosure, when the current block is a boundary block, the partition indicator of the non-boundary block partition syntax indicates that the boundary partition is to be performed on the current block. When the current block is a non-boundary block (or in other words, not a boundary block), the partition indicator in the non-boundary block partition syntax indicates that the current block is not to be split.

No matter the current block is a boundary block or is a non-boundary block, the non-boundary block partition syntax is used so that the method can keep the continuity of CABAC engine as well as fetching the picture boundary so that it will lead to higher coding efficiency. Fetching the picture boundary, in other words, means that performing picture boundary splitting until all leaf nodes are located inside of the boundary.

According to an example of the first aspect of the disclosure, when the partition indicator indicates that the current block is to be split, the method further includes splitting the current block without determining whether the current block is a boundary block.

In such cases, not determining whether the current block is a boundary block may further lead to higher coding efficiency.

According to a second aspect of the disclosure, a method for boundary partition of a current block of a picture is provided. The method includes that an encoder determines a partition indicator, wherein the partition indicator indicates whether the current block is to be split; determines whether the current block is a boundary block when the partition indicator indicates that the current block is not to be split; and performs a boundary partition on the current block when the current block is a boundary block.

No matter whether the current block is a boundary block or a non-boundary block, the partition indicator of a same partition syntax is used, which is benefit to keep the continuity of context-adaptive binary arithmetic coding (CABAC) engine, or in other words, to avoid switching between different partition syntax for boundary and non-boundary blocks, and thus facilitates higher coding efficiency.

According to a third aspect of the present disclosure, a decoder is provided comprising processing circuitry for carrying out the method of the first aspect and any one of the examples of the first aspect.

According to a fourth aspect of the present disclosure, an encoder comprising processing circuitry is provided for carrying out the method of the second aspect and any one of the examples of the second aspect.

According to a fifth aspect of the present disclosure, a computer program product is provided comprising a program code for performing the method of the first aspect and any one of the examples of the first aspect, when the computer program runs on a computing device.

According to a sixth aspect of the present disclosure, a computer program product is provided comprising a program code for performing the method of the second aspect and any one of the examples of the second aspect, when the computer program runs on a computing device.

According to a seventh aspect of the present disclosure, a decoder for boundary partition of a current block of a picture is provided. The decoder includes:

one or more processors; and

a non-transitory computer-readable storage medium coupled to the processors and storing programming for execution by the processors, wherein the programming, when executed by the processors, configures the decoder to carry out the method of the first aspect and any one of the examples of the first aspect.

According to an eighth aspect of the present disclosure, an encoder for boundary partition of a current block of a picture is provided. The encoder includes:

one or more processors; and

a non-transitory computer-readable storage medium coupled to the processors and storing programming for execution by the processors, wherein the programming, when executed by the processors, configures the encoder to carry out the method of the second aspect and any one of the examples of the second aspect.

### BRIEF DESCRIPTION OF DRAWINGS

In the following exemplary embodiments are described in more detail with reference to the attached figures and drawings, in which:

FIG. 1 shows a schematic diagram illustrating an example of a video encoding and decoding system 100;

FIG. 2 shows a schematic diagram illustrating an example of a video encoder 200;

FIG. 3 shows a schematic diagram illustrating an example of a video decoder 300;

FIG. 4A is a schematic diagram illustrating a quad-tree (QT) split according to an embodiment of the present disclosure;

FIG. 4B is a schematic diagram illustrating a binary tree (BT) split in vertical orientation according to an embodiment of the present disclosure;

FIG. 4C is a schematic diagram illustrating a binary tree (BT) split in horizontal orientation according to an embodiment of the present disclosure;

FIG. 4D is a schematic diagram illustrating a ternary tree (TT) split in vertical orientation according to an embodiment of the present disclosure;

FIG. 4E is a schematic diagram illustrating a ternary tree (TT) split in horizontal orientation according to an embodiment of the present disclosure;

FIG. 5 is a flowchart illustrating an embodiment 500 of a method for encoding a bitstream;

FIG. 6 is a flowchart illustrating an embodiment 600 of a method for decoding a bitstream;

FIG. 7 is a schematic diagram illustrating an example of a non-boundary block partition syntax according to an embodiment;

FIG. 8 is a schematic diagram illustrating an example of a boundary partition according to an embodiment;

FIG. 9 is a schematic diagram illustrating an embodiment of a partition and coding tree for a CTU split hierarchically as shown in FIG. 8;

FIG. 10 is a schematic diagram illustrating an embodiment of a forced boundary partition (FBP) for the example of FIG. 8 (marked CU (810));

FIG. 11 is a schematic diagram illustrating an exemplary structure of an apparatus.

### DETAILED DESCRIPTION OF EMBODIMENTS

In the following description, reference is made to the accompanying drawings, which form part of the disclosure, and in which are shown, by way of illustration, specific aspects in which the disclosure may be placed.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

Video coding typically refers to the processing of a sequence of pictures, which form the video or video sequence. The term picture, image or frame may be used/are used synonymously in the field of video coding as well as in this application. Each picture is typically partitioned into a set of non-overlapping blocks. The encoding/decoding of the picture is typically performed on a block level where e.g. inter frame prediction or intra frame prediction are used to generate a prediction block, to subtract the prediction block from the current block (block currently processed/to be processed) to obtain a residual block, which is further transformed and quantized to reduce the amount of data to be transmitted (compression) whereas at the decoder side the inverse processing is applied to the encoded/compressed block to reconstruct the block (video block) for representation.

Conventional methods, for example, an adaptive method and a forced method, are introduced for picture boundary partition. For the adaptive method, only a quad-tree (QT) and a binary tree (BT) split can be selected for the boundary located block, other splitting modes cannot be chosen. In the adaptive method, when a coding unit (CU) is a boundary CU, using boundary syntax; When CU is a non-boundary CU, using non-boundary syntax. Therefore, the adaptive method has to change the syntax for the boundary CU or boundary coding tree units (CTU). This will break the continuality of context-adaptive binary arithmetic coding (CABAC) engine, and also will limit the partition flexibility, which may reduce the coding efficiency. For the forced method, CTU or CU, which is located on the slice/picture boundaries, will be forced to spilt using quad-tree (QT) until the right bottom sample of the leaf node is located within the slice/picture boundary. The forced QT partition does not need to be signaled in the bitstream. The purpose of the forced boundary partition is to make sure all leaf nodes inside of boundary, so that encoder and decoder can process it. The forced method needs to define specific rules for boundary CTUs/CUs (over engineered), so that it will lead to lower coding efficiency. Both the adaptive method and the forced method are not optimized because of their lower coding efficiency.

The present disclosure relates to a versatile boundary partition method, and for example, may be performed on top of multiple tree partition structure in hybrid video coding. The versatile boundary partition method uses a non-boundary block partition syntax for boundary blocks, e.g. boundary CTUs or CUs. The method may keep the continuality of the CABAC engine, and may provide more flexible boundary partition. As a result, the coding efficiency will get improved by using the versatile boundary partition method. Such boundary partition may be advantageously used but not limited in still video picture coding and decoding. In the following the term picture will be used for both, still pictures and video pictures. Instead of the term picture also the term image or frame may be used. In the following, embodiments of a system, an encoder, a decoder, and corresponding methods are described, which can implement the versatile boundary partition according to the present disclosure.

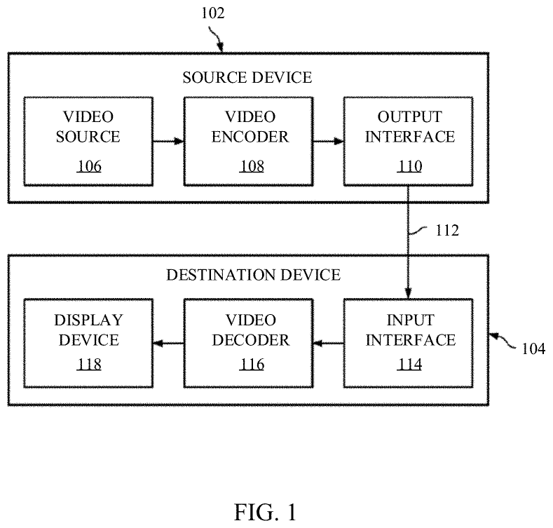

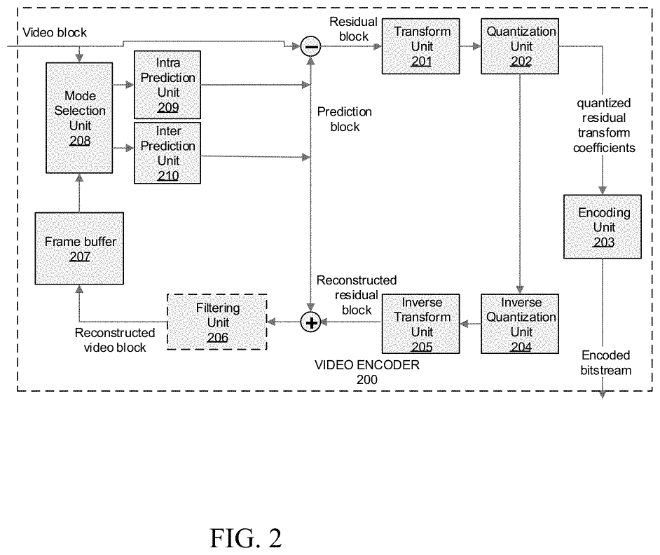

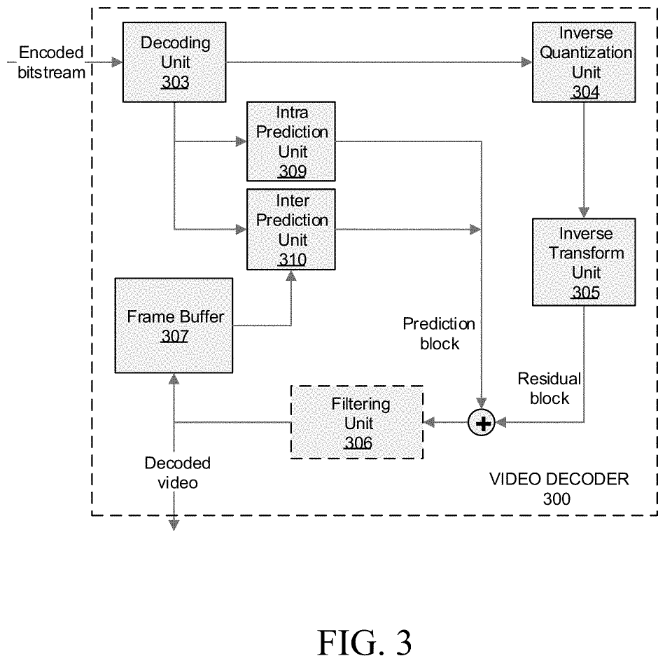

FIG. 1 is a block diagram illustrating an example video encoding and decoding system 100 that may utilize the techniques described in this disclosure, including techniques for encoding and decoding boundary partition. The system 100 is not only applied to video encoding and decoding, but also applied to picture encoding and decoding. As shown in FIG. 1, system 100 includes a source device 102 that generates encoded video data to be decoded at a later time by a destination device 104. Video encoder 200 as shown in FIG. 2, is an example of a video encoder 108 of the source device 102. Video decoder 300 as shown in FIG. 3, is an example of a video decoder 116 of the destination device 104. Source device 102 and destination device 104 may comprise any of a wide range of devices, including desktop computers, notebooks (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 102 and destination device 104 may be equipped for wireless communication.

Destination device 104 may receive the encoded video data to be decoded via a link 112. Link 112 may include any type of medium or device capable of moving the encoded video data from source device 102 to destination device 104. In one example, link 112 may comprise a communication medium to enable source device 102 to transmit encoded video data directly to destination device 104 in real-time. The encoded video data may be modulated according to a communication standard, such as a wireless communication protocol, and transmitted to destination device 104. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 104.

Alternatively, encoded data may be output from output interface 110 to a storage device (not shown in FIG. 1). Similarly, encoded data may be accessed from the storage device by input interface 114. Destination device 104 may access stored video data from storage device via streaming or download. The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 100 may be configured to support one-way or two-way video transmission to support applications such as video streaming, video playback, video broadcasting, and/or video telephony.

In the example of FIG. 1, source device 102 includes a video source 106, a video encoder 108 and an output interface 110. In some cases, output interface 110 may include a modulator/demodulator (modem) and/or a transmitter. In source device 102, video source 106 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 106 is a video camera, source device 102 and destination device 104 may form so-called camera phones or video phones. However, the techniques described in this disclosure may be applicable to video coding in general, and may be applied to wireless and/or wired applications.

The captured, pre-captured, or computer-generated video may be encoded by video encoder 108. The encoded video data may be transmitted directly to destination device 104 via output interface 110 of source device 102. The encoded video data may also (or alternatively) be stored onto the storage device for later access by destination device 104 or other devices, for decoding and/or playback.

Destination device 104 includes an input interface 114, a video decoder 116, and a display device 118. In some cases, input interface 114 may include a receiver and/or a modem. Input interface 114 of destination device 104 receives the encoded video data over link 112. The encoded video data communicated over link 112, or provided on the storage device, may include a variety of syntax elements generated by video encoder 108 for use by a video decoder, such as video decoder 116, in decoding the video data. Such syntax elements may be included with the encoded video data transmitted on a communication medium, stored on a storage medium, or stored a file server.

Display device 118 may be integrated with, or external to, destination device 104. In some examples, destination device 104 may include an integrated display device and also be configured to interface with an external display device. In other examples, destination device 104 may be a display device. In general, display device 118 displays the decoded video data to a user, and may comprise any of a variety of display devices such as a liquid crystal display (LCD), a plasma display, an organic light emitting diode (OLED) display, or another type of display device.

Video encoder 108 and video decoder 116 may operate according to any kind of video compression standard, including but not limited to MPEG-2, MPEG-4, ITU-T H.263, ITU-T H.264/MPEG-4, Part 10, Advanced Video Coding (AVC), the High Efficiency Video Coding (HEVC), ITU-T H.266/Next Generation Video Coding (NGVC) standard.

It is generally contemplated that video encoder 108 of source device 102 may be configured to encode video data according to any of these current or future standards. Similarly, it is also generally contemplated that video decoder 116 of destination device 104 may be configured to decode video data according to any of these current or future standards.

Video encoder 108 and video decoder 116 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 108 and video decoder 116 may be included in one or more encoders or decoders, either of which may be integrated as part of a combined encoder/decoder (CODEC) in a respective device.

In video coding specifications, a video sequence typically includes a series of pictures. However, it is noted that the present disclosure is also applicable to fields in case interlacing is applied. Video encoder 108 may output a bitstream that includes a sequence of bits that forms a representation of coded pictures and associated data. Video decoder 116 may receive a bitstream generated by video encoder 108. In addition, video decoder 116 may parse the bitstream to obtain syntax elements from the bitstream. Video decoder 116 may reconstruct the pictures of the video data based at least in part on the syntax elements obtained from the bitstream. The process to reconstruct the video data may be generally reciprocal to the process performed by video encoder 108.

FIG. 2 shows a schematic diagram illustrating an example of a video encoder 200. The video encoder 200 is not only applied to video encoding, but also applied to picture encoding. The video encoder 200 comprises an input for receiving input blocks of frames or pictures of a video stream and an output for generating an encoded video bit stream. The video encoder 200 is adapted to apply prediction, transformation, quantization, and entropy coding to the video stream. The transformation, quantization, and entropy coding are carried out respectively by a transform unit 201, a quantization unit 202 and an encoding unit 203 so as to generate as an output the encoded video bit stream.

The video stream corresponds to a plurality of frames, wherein each frame is divided into blocks of a certain size that are either intra or inter coded. The blocks of for example the first frame of the video stream are intra coded by means of an intra prediction unit 209. An intra frame is coded using only the information within the same frame, so that it can be independently decoded and it can provide an entry point in the bit stream for random access. Blocks of other frames of the video stream are inter coded by means of an inter prediction unit 210: information from coded frames, which are called reference frames, are used to reduce the temporal redundancy, so that each block of an inter coded frame is predicted from a block of the same size in a reference frame. A mode selection unit 208 is adapted to select whether a block of a frame is to be processed by the intra prediction unit 209 or the inter prediction unit 210.

For performing inter prediction, the coded reference frames are processed by an inverse quantization unit 204, an inverse transform unit 205, a filtering unit 206 (optional) so as to obtain the reference frames that are then stored in a frame buffer 207. Particularly, reference blocks of the reference frame can be processed by these units to obtain reconstructed reference blocks. The reconstructed reference blocks are then recombined into the reference frame.

The inter prediction unit 210 comprises as input a current frame or picture to be inter coded and one or several reference frames or pictures from the frame buffer 207. Motion estimation and motion compensation are applied by the inter prediction unit 210. The motion estimation is used to obtain a motion vector and a reference frame based on certain cost function. The motion compensation then describes a current block of the current frame in terms of the transformation of a reference block of the reference frame to the current frame. The inter prediction unit 210 outputs a prediction block for the current block, wherein said prediction block minimizes the difference between the current block to be coded and its prediction block, i.e. minimizes the residual block. The minimization of the residual block is based e.g., on a rate-distortion optimization procedure.

The difference between the current block and its prediction, i.e. the residual block, is then transformed by the transform unit 201. The transform coefficients are quantized and entropy coded by the quantization unit 202 and the encoding unit 203. The encoded video bit stream comprises intra coded blocks and inter coded blocks.

FIG. 3 shows a schematic diagram illustrating an example of a video decoder 300. The video decoder 300 is not only applied to video decoding, but also applied to picture decoding. The video decoder 300 comprises particularly a frame buffer 307, an inter prediction unit 310. The frame buffer 307 is adapted to store at least one reference frame obtained from the encoded video bit stream. The inter prediction unit 310 is adapted to generate a prediction block of a current block of a current frame from a reference block of the reference frame.

The decoder 300 is adapted to decode the encoded video bit stream generated by the video encoder 200, and both the decoder 300 and the coder 200 generate identical predictions. The features of the frame buffer 307, the inter prediction unit 310 are similar to the features of the frame buffer 207, the inter prediction unit 210, of FIG. 2.

Particularly, the video decoder 300 comprises units that are also present in the video encoder 200 like e.g., an inverse quantization unit 304, an inverse transform unit 305, a filtering unit 306 (optional) and an intra prediction unit 309, which respectively correspond to the inverse quantization unit 204, the inverse transform unit 205, the filtering unit 206 and the intra prediction unit 209 of the video encoder 200. A decoding unit 303 is adapted to decode the received encoded video bit stream and to correspondingly obtain quantized residual transform coefficients. The quantized residual transform coefficients are fed to the inverse quantization unit 304 and an inverse transform unit 305 to generate a residual block. The residual block is added to a prediction block and the addition is fed to the filtering unit 306 to obtain the decoded video. Frames of the decoded video can be stored in the frame buffer 307 and serve as a reference frame for inter prediction.

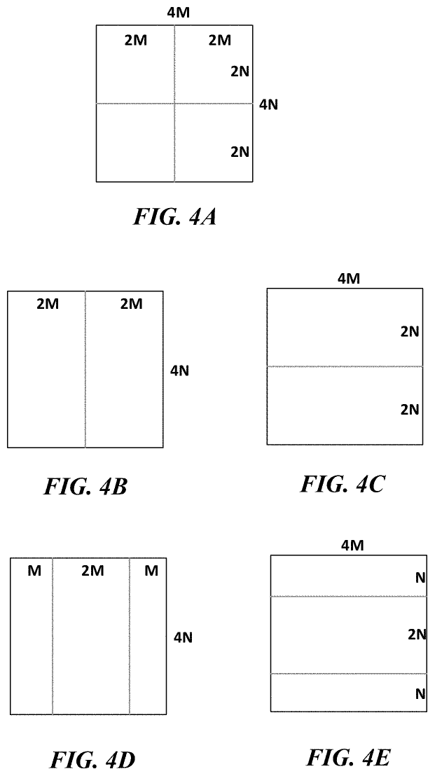

The video encoder 200 may split the input video frame into blocks before coding. The term “block” in this disclosure is used for any type block or for any depth block, for example, the term “block” is included but not limited to root block, block, sub-block, leaf node, and etc. The blocks to be coded do not necessarily have the same size. One picture may include blocks of different sizes and the block rasters of different pictures of video sequence may also differ. FIGS. 4A-4E illustrate Coding Tree Unit (CTU)/Coding Unit (CU) splitting mode in VVC.

FIG. 4A illustrates a block partition structure by adopting a quad-tree (QT) split. The QT is a tree structure for block partition in which a node of size 4M×4N may be split into four child nodes of size 2M×2N.

FIG. 4B illustrates a block partition structure by adopting a binary tree (BT) split in vertical orientation.

FIG. 4C illustrates a block partition structure by adopting a binary tree (BT) split in horizontal orientation. The BT is a tree structure for block partition in which a node of size 4M×4N may either be horizontally split into two child nodes of size 4M×2N or vertically split into two child nodes of size 2M×4N.

FIG. 4D illustrates a block partition structure by adopting a ternary tree (TT) split in vertical orientation.

FIG. 4E illustrates block partition structure by adopting a ternary tree (TT) split in horizontal orientation. The TT is a tree structure for block partition in which a node of size 4M×4N may either be horizontally split into three child nodes of size 4M×N, 4M×2N and 4M×N, respectively; or vertically split into three child nodes of size M×4N, 2M×4N and M×4N, respectively. Among the three child nodes shown in FIG. 4D or FIG. 4E, the largest node is positioned in the center.

Quad-tree plus binary tree (QTBT) is a quad-tree plus binary tree structure in which a block is first partitioned using quad-tree split, then each quad-tree child node may be further partitioned using binary tree split. Quad-tree plus binary tree or ternary tree (QT-BT/TT) is a quad-tree plus binary tree or ternary tree structure in which a block is first partitioned using quad-tree split, then each quad-tree child node may be further partitioned using binary tree or ternary tree split.

For a block associated with a particular depth, encoder 200 determines which partition type (including no further split) is used and signals the determined partition type explicitly or implicitly (e.g., the partition type may be derived from predetermined rules) to decoder 300. Encoder 200 may determine the partition type to use, for example, based on checking rate-distortion costs for the block using different partition types.

The following versatile boundary partition is disclosed in relation to video coding (or picture of video coding), and also for still image coding (or still picture coding).

An embodiment of the versatile boundary partition in this disclosure is defined by the following rules:
no matter whether the block is a boundary block (isB or isBoundary) or a non-boundary block (in other words, not a boundary block, (noB or noBoundary)), a non-boundary block partition syntax (which may be also referred to as conventional non-boundary block partition syntax, or regular block partition syntax, or unchanged regular block partition syntax, or Versatile block partition syntax) is used, where isB or isBoundary indicates that a CTU/CU located at a picture boundary and only partially within the picture; noB or noBoundary indicates that the CTU/CU is completely located within the picture;
if the no split mode is parsed for the boundary CTU, use a boundary partition to fetch the boundary, where the boundary partition comprises but is not limited to a forced boundary partition (FBP);
after the boundary partition, no further partition (leaf node).
   In the disclosure, isBoundary is abbreviated as isB, and noBoundary is abbreviated as noB.

Whether or not a CTU is a boundary CTU is determined, for instance, by comparing the position of the CTU (in particular, a suitable pixel position in the CTU) with the position of the boundary (or the vertical/horizontal image size in samples). In the code, the CTU has fixed pre-defined size, for instance 128×128 or 64×64 as in HEVC. The picture will split into CTUs without overlapping. As an embodiment, the encoder/decoder will check the left-top pixel of the CTU, and compare it with the boundary. If the left-top pixel is located inside of the picture boundary, the CTU is not an outside block (non-outside block). If the left-top pixel is not located inside of the picture boundary, the CTU is an outside block (outside). For the CTU is not an outside block, the encoder/decoder will check the right-bottom pixel of the CTU, and compare it with the boundary. If the right-bottom pixel is located outside of the picture boundary, the CTU is a boundary CTU (isB). If the right-bottom pixel is not located outside of the picture boundary, the CTU is a non-boundary CTU (noB). In this example, the encoder/decoder will check the left-top pixel first, and to determine the current CTU is an outside CTU or non-outside CTU. For the non-outside CTU, the encoder/decoder will check the right-bottom pixel second, and to determine the current CTU is a boundary block (isB) or a non-boundary block (noB). This way of determining whether a partitioning block is a boundary block is just an example. There are other methods to determine whether a partitioning block is a boundary block or not.

Moreover, this way of determining whether a partitioning block is located on a boundary or not is not only applied to CTUs, but can also be used for CUs and any partition blocks resulting from splitting a CTU or some block within the partitioning hierarchy.

FBP is a kind of non-signaling boundary partition, because no further signaling is needed for FBP, e.g. the encoder and the decoder are both configured to perform the same partition in case of forced boundary partition. The forced partition (or splitting) is thus performed in order to partition the boundary portion. No partition information is necessary for the forced splitting, it can be predefined.

The term “block” in the present disclosure is a generalized term which includes but not limited to root block, block, sub-block, leaf node, and etc.

The versatile boundary partition could be explained in a pseudo code as follows (decoder for example):

parse_splitting_indicator
if (no split) then

if (isBoundary) then

Do FBP

Else

Do no split

splitting_indicator is an example of the partition indicator.

The above applies to both encoder 200 and decoder 300. The following processing 500 and 600 explain the above rules and the pseudo code in more detail.

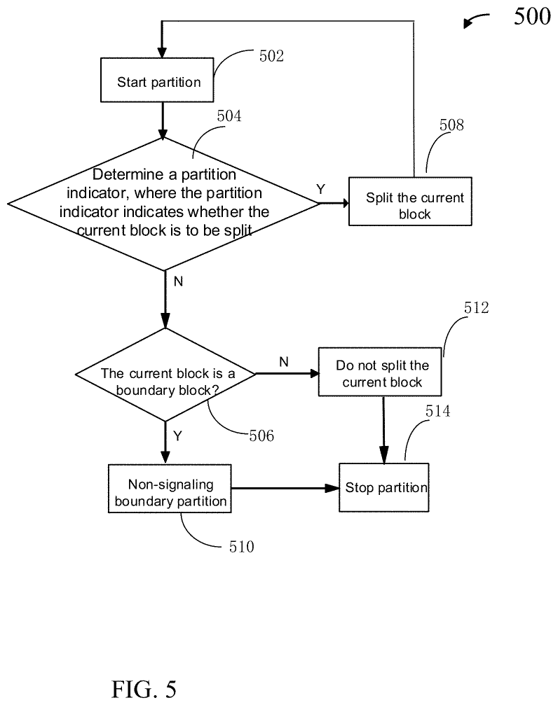

FIG. 5 is an illustration of an embodiment 500 of a method using the versatile boundary partition processing, which may be performed by the source device 102 as shown in FIG. 1, by the video encoder 200 as shown in FIG. 2 or any other encoder, e.g. a still picture encoder.

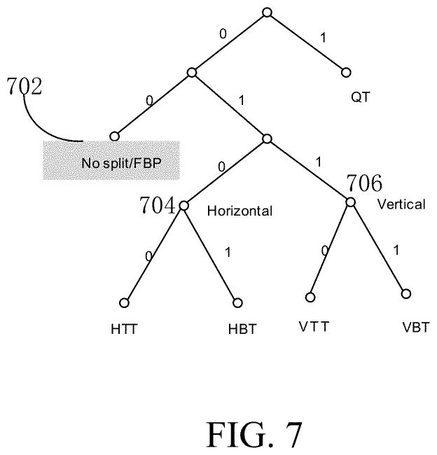

In the method of FIG. 5, the method is initiated at step 502 to start the partition. For a current block, at step 504, the encoder determines a partition indicator, where the partition indicator indicates whether the current block is to be split. The partition indicator may be determined according to a non-boundary block partition syntax. An embodiment of the non-boundary block partition syntax is shown in FIG. 7. The partition indicator includes but is not limited to a partition flag or splitting_indicator comprising one or more bits. The encoder may perform Rate-Distortion Optimization (RDO) cost estimations to determine the partition indicator.

For instance, the cost function may be a measure of a difference between the current block and the candidate block, i.e. a measure of the residual of the current block with respect to the candidate block. For example, the cost function may be a sum of absolute differences (SAD) between all pixels (samples) of the current block and all pixels of the candidate block in the candidate reference picture. However, in general, any similarity metric may be employed, such as mean square error (MSE) or structural similarity metric (SSIM).

However, the cost function may also be the number of bits that are necessary to code such inter-block and/or distortion resulting from such coding. Thus, a rate-distortion optimization procedure may be used to decide on the motion vector selection and/or in general on the encoding parameters such as whether to use inter or intra prediction for a block and with which settings.

In this versatile boundary partition processing, no matter whether the current block is a boundary block (isB) or a non-boundary block (noB), the partition indicator of a same partition syntax is used, where isB indicates that the block, e.g. a CTU/CU (i.e. CTU or CU), is located at a picture boundary and only partially within the picture; and noB indicates that the block, e.g. a CTU/CU, is completely located within the picture, which may include that the non-boundary block is located at the picture boundary but does not extend beyond the boundary. Therefore, the encoder can determine the partition indicator without firstly determining whether the current block is a boundary block.

When the partition indicator indicates that the current block is not to be split, the encoder determines whether the current block is a boundary block at step 506. The determination may be done for any kind of a block, e.g., a coding unit (CU), a coding tree unit (CTU), including any kind of a block that has been partitioned, split or other way derived from a coding tree unit (or any other kind of a root block).

When the partition indicator indicates that the current block is to be split, the encoder splits the current block at step 508, without determining whether the current block is a boundary block. Then the procedures return to step 502 to start partition of next level.

When the current block is a boundary block, the partition indicator of the non-boundary block partition syntax indicates that the boundary partition is to be performed on the current block. As such, when the encoder determines that the current block is a boundary block, the encoder performs a boundary partition (e.g. a forced boundary partition (FBP) or any other non-signaling boundary partition) on the current block at step 510. If all boundary partitioned leaf nodes are entirely inside of the picture boundary, the method stops partition at step 514. It means, no further partition (leaf node) is executed after the boundary partition is performed. This will preserve the largest possible leaf nodes as well as all leaf nodes are entirely inside of the picture boundary.

When the current block is not a boundary block, the partition indicator in the non-boundary block partition syntax indicates that the current block is not to be split. As such, when the encoder determines that the current block is not a boundary block, the encoder does not split the current block at step 512. After step 512, the method may stop partition at step 514 after receiving an indicator to indicate no further split.

After step 504, the encoder may encode a value of the partition indicator to the bitstream, and send the bitstream to decoder (Not shown in FIG. 5).

As discussed above, in this versatile boundary partition processing, it does not matter whether the block is a boundary block or a non-boundary block at step 504. Therefore, the encoder can use a regular (e.g. non-boundary) block partition syntax. The encoder in the method 500 may use an unchanged regular (e.g. non-boundary) block partition syntax to partition boundary located CTU/CU, the semantics of the partition syntax can be (at least partially) different for boundary and non-boundary blocks, e.g. CTU/CU. The partition indicator may be indicated by using one or more bits in the bitstream. Taking 00 as an example: for a normal or non-boundary block (e.g. CTU/CU), 00 indicates to perform no splitting (no split); for a boundary block (e.g. CTU/CU), 00 indicates to perform boundary partition (e.g. non-signaling boundary partition). Since the regular block partition syntax is used, this versatile boundary partition can keep the continuality of the CABAC engine, and more flexible boundary partition can be achieved.

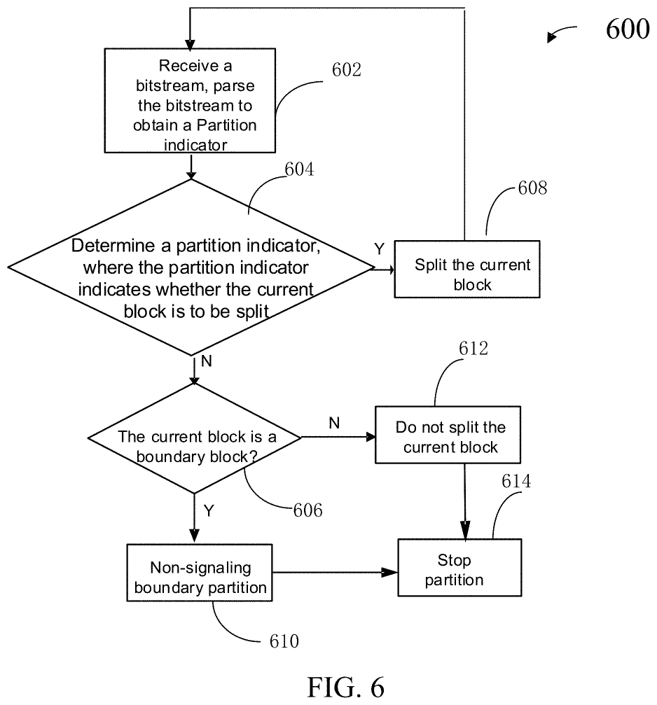

FIG. 6 is an illustration of an embodiment 600 of a method using the versatile boundary partition processing, which may be performed by the destination device 104 as shown in FIG. 1, the video decoder 300 as shown in FIG. 3 or any other decoder, e.g. a still picture decoder.

In the method 600 of FIG. 6, the method is initiated at step 602 to receive the bitstream, for example, from an encoder, where the bitstream includes a partition indicator and picture data. The decoder may parse the bitstream to obtain the partition indicator at step 602. At step 604, the decoder determines whether the partition indicator indicates that a current block is to be split or not. The decoder may determine whether the partition indicator indicates that a current block is to be split according to a non-boundary block partition syntax. An embodiment of the non-boundary block partition syntax is shown in FIG. 7. The partition indicator includes but is not limited to a partition flag comprising one or more bits.

In this versatile boundary partition processing, no matter whether the current block is a boundary block (isB) or a non-boundary block (noB), the partition indicator of a same partition syntax is used, where isB indicates that the block, e.g. a CTU/CU, is located at a picture boundary and only partially within the picture; and noB indicates that the block, e.g. CTU/CU, is completely located within the picture, which may include that the non-boundary block is located at the picture boundary but does not extend beyond the boundary. Therefore, the decoder can determine the partition indicator without firstly determining whether the current block is a boundary block.

When the partition indicator indicates that the current block is not to be split, the decoder determines whether the current block is a boundary block at step 606. Similarly as for the boundary block in step 506.

When the partition indicator indicates that the current block is to be split, the decoder splits the current block at step 608, without determining whether the current block is a boundary block. Then the procedures return to step 602.

When the current block is a boundary block, the partition indicator of the non-boundary block partition syntax indicates that the boundary partition is to be performed on the current block. As such, when the decoder determines that the current block is a boundary block, the decoder performs a boundary partition (e.g. a forced boundary partition (FBP) or any other non-signaling boundary partition) on the current block at step 610. If all boundary partitioned leaf nodes are entirely inside of the picture boundary, the method stops partition at step 614. It means, no further partition (leaf node) is executed after the boundary partition is performed.

When the current block is not a boundary block, the partition indicator in the non-boundary block partition syntax indicates that the current block is not to be split. As such, when the decoder determines the current block is not a boundary block, the decoder does not split the current block at step 612. After step 612, the method may stop partition at step 616 after receiving an indicator to indicate no further split.

As discussed above, in this versatile boundary partition processing, the decoder determines whether the partition indicator indicates that the current block is to be split or not. Therefore, the decoder can parse and use a regular (e.g. anon-boundary) block partition syntax. The decoder in the method 600 may use an unchanged regular block partition syntax to partition boundary located blocks, e.g. CTU/CU, wherein the semantics of the block partition syntax can be different (at least partially) for boundary and non-boundary blocks, e.g. CTU/CU. The partition indicator may be indicated by using one or more bits in the bitstream. Taking 00 as an example: for normal or non-boundary block (e.g. CTU/CU), 00 indicates to perform no splitting (no split); for a boundary block (e.g. CTU/CU), 00 indicates to perform boundary partition (e.g. non-signaling boundary partition). Since the regular block partition syntax is used, this versatile boundary partition can keep the continuality of the CABAC engine, and more flexible boundary partition can be achieved.

FIG. 7 is an example of a non-boundary block partition syntax (which may also be referred to as a conventional non-boundary block partition syntax, or a regular block partition syntax, or a unchanged regular block partition syntax, or Versatile block partition syntax) according to an embodiment, where whether the partition indicator (as shown in FIGS. 5-6) indicates that a current block is to be split or not is determined according to a common block partition syntax, which is common for non-boundary blocks and boundary blocks and which comprises a partition indicator (or partition indicator value) which for non-boundary blocks indicates that the current block is not to be split and which for boundary blocks indicates that the boundary partition is to be performed on the current block. In other words, that the current block is to be split according to the (predetermined) boundary partition. Put differently, the same partition indicator (or partition indicator value, e.g. 00 in FIG. 7) has two different meanings depending on whether the current block is a boundary block or not, e.g. whether the current block is a boundary block or a non-boundary block. Decision tree of FIG. 7 will be checked at each level and each block. As shown in FIG. 7, if noB, the box 702 in FIG. 7 means “No split”; if isB, the box 702 in FIG. 7 means “forced block partition (FBP)”. No matter the current block is isB or noB, the syntax is unchanged. The label 1 on the nodes represents QT split, and the label 0 on the nodes represents non-QT split. Horizontal split in node 704 includes horizontal TT (HTT) and horizontal BT (HBT). Vertical split in node 706 includes vertical TT (VTT) and vertical BT (VBT).

Taking the partition indicator is a partition flag, the versatile boundary partition could be specified in a pseudo code as shown in the following table 1 (decoder for example):

TABLE 1

| | |
|---|---|
| parse_splitting_flag[ x0 ][ y0 ] | ae(v) |
| if ( ! parse_splitting_flag[ x0 ][ y0 ]){ | |

| | |
|---|---|
| if ( bBoundary){ | ae(v) |

Do FBP

} else {

Do no split

}

In particular, at each CTU/CU level, a flag named parse_splitting_flag is included into the bitstream, which indicates whether the CTU/CU is to be split or not. If the CTU/CU is not split, another bBoundary is checked, specifying whether the block is a boundary block or not. If the block is on the boundary, do the FBP. Otherwise, do not split. This hierarchical subdivision is continued until none of the resulting blocks is further subdivided. The array indices x0, y0 specify the location (x0, y0) of the top-left luma sample of the considered coding block relative to the top-left luma sample of the picture. In the disclosure, bBoundary is abbreviated as isB, and splitting_flag is an example of the partition indicator.

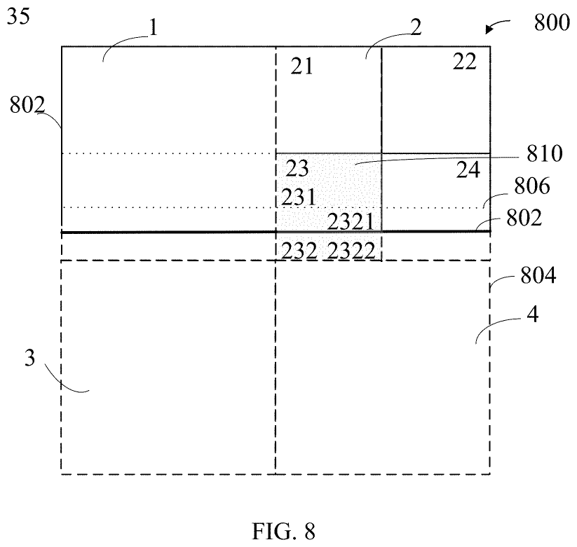

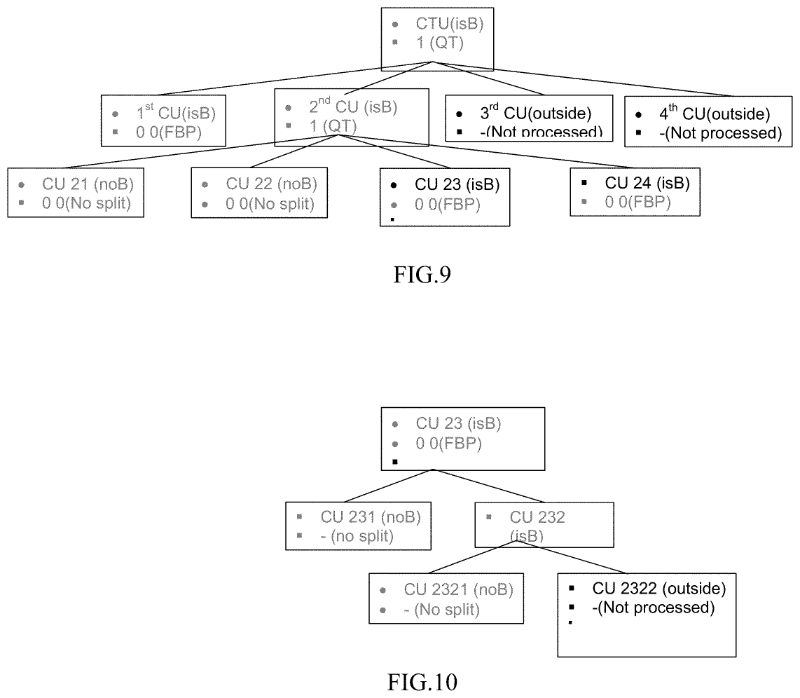

FIGS. 8-10 show an embodiment to further explain the versatile boundary partition for both encoder side and decoder side. The partition follows a quad-tree structure in order to adapt to various local characteristics. FIG. 8 shows an example of a bottom boundary block partition. FIG. 9 is a schematic diagram illustrating an embodiment of a partition and coding tree for a CTU split hierarchically in compliance with the quad-tree structure on FIG. 8. In particular, the coding tree defines the regular block partition syntax, which specifies the subdivision of the CTU into CUs. Similarly as a CTU, a CU consists of a square block of samples and the syntax associated with these sample blocks. Thus, as shown in FIG. 9, the partition is performed hierarchically, starting from the CTU (hierarchy depth 0, which may also be referred to as root block) which may be but does not have to be subdivided into four (in quad-tree) CUs of hierarchy depth 1.

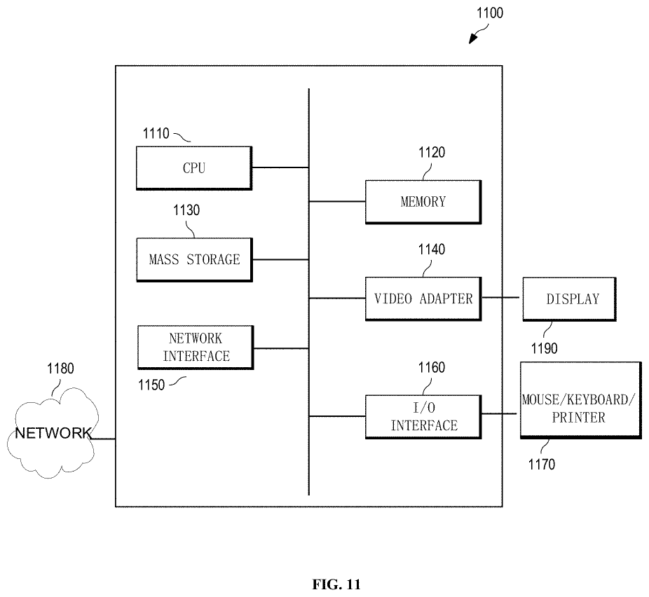

FIG. 8 shows an example of a bottom boundary block partition. The thick solid line 802 indicates the picture boundary. The CTU 800 in FIG. 8 is a boundary block, the inside part of CTU is illustrated by a solid line 802 and the outside part of CTU is illustrated by a dashed line 804. By performing quad-tree (QT) partition, the CTU 800 in FIG. 8 is split into CU1, CU2, CU3 and CU4, i.e., 1^{st} CU, 2^{nd} CU, 3^{rd} CU, and 4^{th} CU. The inside part of CTU includes portions of CU1 and CU2. The outside part of CTU includes portions of CU1 and CU2, CU3 and CU4. The dotted line 806 illustrates as forced boundary partition in this example. The signaling and partition of grayed block 810 are mainly discussed in FIGS. 9-10. This coding order is also referred to as z-scan. It ensures that for each CU, except those located at the top or left boundary of a slice, all samples above the CU and left to the CU have already been coded, so that the corresponding samples can be used for intra prediction and the associated coding parameters can be used for predicting the coding parameters of the current CU.

In FIG. 9, 0 indicates signaling 0 for the bin, 1 indicates signaling 1 for the bin, and “−” indicates no signaling. Bins means the flags before entropy coding. Bits means bins after entropy coding. Before entropy coding, flags are represented with bins. After entropy coding, bins are coded into bits. 0 represents no further splitting, or non-QT splitting; 1 represents further QT splitting. IsB indicates CTU/CU located only partially within the picture, at boundary; noB indicates CTU/CU is completely located within the picture, not located at the boundary; outside indicates CTU/CU completely located outside of the picture, on other words, when the current block is completely outside of the picture, the current block is an outside-block.

According to the procedures in FIG. 5 or FIG. 6, a partition indicator indicates the current block CTU 800 is to be split at step 504 or 604. In FIGS. 8 and 9, the CTU 800 is split (in quad-tree) into 1^{st} CU, 2^{nd} CU, 3^{rd} CU, 4^{th} CU of the first hierarchy depth (depth-1 CUs), following the step 508 or 608. The CTU 800 is located on boundary (isB).

The 3^{rd} CU and the 4^{th} CU are outside the boundary, and are not processed in FIG. 9. Therefore no signaling is for the 3^{rd} CU or the 4^{th} CU. The system determines that the 1^{st} CU is not to be split based on the partition indicator. The 1^{st} CU is located on the boundary (isB), then forced block partition is performed for 1^{st} CU. 00 is signaled for 1^{st} CU, which indicates FBP. Forced block partition, as one of kind of boundary partition, is not depending on the partition indicator. Forced block partition is also called as a forced boundary partition (FBP).

The 2^{nd} CU is further split (in quad-tree) into CUs 21, 22, 23 and 24 of hierarchy depth 2 (depth-2 CUs). For the CU 21 and CU 22, no further split, and both are not located on the boundary (noB). Therefore, 00 is signaled for CU 21 or CU 22, which indicates no split. The CU 23 or CU 24 is located on the boundary (isB). 00 is signaled for CU 23 or CU 24, which indicates FBP.

There are multiple types of FBP. FIG. 10 is a schematic diagram illustrating an embodiment of a forced boundary partition (FBP) for the example of FIG. 8 (marked CU (810)) and FIG. 9. FIG. 10 takes CU 23 for further explanation. CU 23 is further split (in FBP) into CUs 231 and 232 of hierarchy depth 3 (depth-3 CUs). CU 231 is no further split, and is not on the boundary. CU 232 is on the boundary, and is further split (in HBT) into CUs 2321 and 2322 of hierarchy depth 4 (depth-4 CUs). CU 2321 is not on the boundary, and no further split. CU 2322 is outside of the boundary, and is not processed. FIG. 10 performs the FBP, therefore no further signaling is needed. The forced splitting is thus performed in order to partition the boundary portion so that preserve the largest possible leaf nodes as well as all leaf nodes are entirely inside of the picture boundary. No partition information is necessary for the forced splitting, it can be predefined, as already discussed above.

FIG. 11 is a block diagram of an apparatus 1100 that can be used to implement various embodiments, for example, method embodiments as shown in FIGS. 4-10. The apparatus 1100 may be the source device 102 as shown in FIG. 1, or the video encoder 200 as shown in FIG. 2, or the destination device 104 as shown in FIG. 1, or the video decoder 300 as shown in FIG. 3. Additionally, the apparatus 1100 can host one or more of the described elements. In some embodiments, the apparatus 1100 is equipped with one or more input/output devices, such as a speaker, microphone, mouse, touchscreen, keypad, keyboard, printer, display, and the like. The apparatus 1100 may include one or more central processing units (CPUs) 1110, a memory 1120, a mass storage 1130, a video adapter 1140, and an I/O interface 1160 connected to a bus. The bus is one or more of any type of several bus architectures including a memory bus or memory controller, a peripheral bus, a video bus, or the like.

The CPU 1110 may have any type of electronic data processor. The memory 1120 may have, or be, any type of system memory such as static random access memory (SRAM), dynamic random access memory (DRAM), synchronous DRAM (SDRAM), read-only memory (ROM), a combination thereof, or the like. In an embodiment, the memory 1120 may include ROM for use at boot-up, and DRAM for program and data storage for use while executing programs. In embodiments, the memory 1120 is non-transitory. The mass storage 1130 includes any type of storage device that stores data, programs, and other information and to make the data, programs, and other information accessible via the bus. The mass storage 1130 includes, for example, one or more of a solid state drive, hard disk drive, a magnetic disk drive, an optical disk drive, or the like.

The video adapter 1140 and the I/O interface 1160 provide interfaces to couple external input and output devices to the apparatus 1100. For example, the apparatus 1100 may provide SQL command interface to clients. As illustrated, examples of input and output devices include a display 1190 coupled to the video adapter 1140 and any combination of mouse/keyboard/printer 1170 coupled to the I/O interface 1160. Other devices may be coupled to the apparatus 1100, and additional or fewer interface cards may be utilized. For example, a serial interface card (not shown) may be used to provide a serial interface for a printer.

The apparatus 1100 also includes one or more network interfaces 1150, which includes wired links, such as an Ethernet cable or the like, and/or wireless links to access nodes or one or more networks 1180. The network interface 1150 allows the apparatus 1100 to communicate with remote units via the networks 1180. For example, the network interface 1150 may provide communication to database. In an embodiment, the apparatus 1100 is coupled to a local-area network or a wide-area network for data processing and communications with remote devices, such as other processing units, the Internet, remote storage facilities, or the like.

As discussed above, no matter the block is a boundary block or a non-boundary block, the non-boundary block partition syntax is used in the versatile boundary partition methods, and apparatus (for example, encoder and decoder). The non-boundary block partition syntax is unchanged so that the continuality of CABAC engine is kept. The partition of boundary located on CTU/CU is more flexible. Moreover, there is no need to extend the maximum allowed binary and ternary tree depth (MaxBTTDepth) for boundary partition. As a result, the coding efficiency will get improved.

Implementations of the subject matter and the operations described in this disclosure may be implemented in digital electronic circuitry, or in computer software, firmware, or hardware, including the structures disclosed in this disclosure and their structural equivalents, or in combinations of one or more of them. Implementations of the subject matter described in this disclosure may be implemented as one or more computer programs, i.e., one or more modules of computer program instructions, encoded on computer storage medium for execution by, or to control the operation of, data processing apparatus. Alternatively or in addition, the program instructions may be encoded on an artificially-generated propagated signal, for example, a machine-generated electrical, optical, or electromagnetic signal that is generated to encode information for transmission to suitable receiver apparatus for execution by a data processing apparatus. A computer storage medium, for example, the computer-readable medium, may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical and/or non-transitory components or media (for example, multiple CDs, disks, or other storage devices).

In some implementations, the operations described in this disclosure may be implemented as a hosted service provided on a server in a cloud computing network. For example, the computer-readable storage media may be logically grouped and accessible within a cloud computing network. Servers within the cloud computing network may include a cloud computing platform for providing cloud-based services. The terms “cloud,” “cloud computing,” and “cloud-based” may be used interchangeably as appropriate without departing from the scope of this disclosure. Cloud-based services may be hosted services that are provided by servers and delivered across a network to a client platform to enhance, supplement, or replace applications executed locally on a client computer. The circuit may use cloud-based services to quickly receive software upgrades, applications, and other resources that would otherwise require a lengthy period of time before the resources may be delivered to the circuit.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program may be deployed to be executed on one computer or on multiple computers that are located at one site or distributed across multiple sites and interconnected by a communication network.

The processes and logic flows described in this disclosure may be performed by one or more programmable processors executing one or more computer programs to perform actions by operating on input data and generating output. The processes and logic flows may also be performed by, and apparatus may also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer may be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory may be supplemented by, or incorporated in, special purpose logic circuitry.

While this disclosure contains many specific implementation details, these should not be construed as limitations on the scope of any implementations or of what may be claimed, but rather as descriptions of features specific to particular implementations of particular implementations. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for boundary partition of a current block, wherein the method is performed by a decoder and the method comprises:
receiving a bitstream, wherein the bitstream includes a partition indicator;
parsing the bitstream to obtain the partition indicator;
determining whether the current block is to be split based on the partition indicator;
determining whether the current block is a boundary block when the current block is not to be split; and
performing a boundary partition on the current block when the current block is a boundary block.

2. The method of claim 1, wherein no matter whether the current block is a boundary block (isB) or a non-boundary block (noB), a non-boundary block partition syntax is used, and wherein non-boundary block partition syntax includes the partition indicator.

3. The method of claim 2, wherein when the current block is a boundary block, the partition indicator of the non-boundary block partition syntax indicates that the boundary partition is to be performed on the current block.

4. The method of claim 2, wherein when the current block is not a boundary block, the partition indicator in the non-boundary block partition syntax indicates that the current block is not to be split.

5. The method of claim 1, wherein the method comprises:
performing the boundary partition until all leaf nodes are entirely inside of a picture boundary.

6. The method of claim 1, wherein when the current block is to be split, the method further comprises:
splitting the current block without determining whether the current block is a boundary block.

7. The method of claim 1, wherein when the current block is located only partially within a picture, the current block is a boundary block; and when the current block is completely located within the picture, the current block is a non-boundary block.

8. The method of claim 1, wherein the partition indicator is a flag included into the bitstream, which indicates whether the current block is to be split.

9. The method of claim 1, wherein the boundary partition includes a forced boundary partition (FBP), which is not dependent on the partition indicator.

10. A method for boundary partition of a current block of a picture, wherein the method is performed by an encoder and the method comprises:
determining a partition indicator, wherein the partition indicator indicates whether the current block is to be split;
determining whether the current block is a boundary block when the partition indicator indicates that the current block is not to be split; and
performing a boundary partition on the current block when the current block is a boundary block.

11. The method of claim 10, wherein no matter whether the current block is a boundary block (isB) or a non-boundary block (noB), a non-boundary block partition syntax is used, and wherein non-boundary block partition syntax includes the partition indicator.

12. The method of claim 11, wherein when the current block is a boundary block, the partition indicator of the non-boundary block partition syntax indicates that the boundary partition is to be performed on the current block.

13. The method of claim 11, wherein when the current block is not a boundary block, the partition indicator in the non-boundary block partition syntax indicates that the current block is not to be split.

14. The method of claim 10, wherein when the current block is to be split, the method further comprises:
splitting the current block without determining whether the current block is a boundary block.

15. The method of claim 10, wherein the boundary partition is a non-signaling boundary partition.

16. The method of claim 10, wherein the boundary partition includes a forced boundary partition (FBP), which is not dependent on the partition indicator.

17. A decoder or an encoder for boundary partition of a current block of a picture, comprising:
one or more processors; and
a non-transitory computer-readable storage medium coupled to the processors and storing programming for execution by the processors, wherein the programming, when executed by the processors, configures the decoder to carry out:
determining whether the current block is to be split based on a partition indicator;
determining whether the current block is a boundary block when the current block is not to be split; and
performing a boundary partition on the current block when the current block is a boundary block.

18. The decoder or encoder of claim 17, wherein no matter whether the current block is a boundary block (isB) or a non-boundary block (noB), a non-boundary block partition syntax is used, and wherein non-boundary block partition syntax includes the partition indicator.

19. The decoder or encoder of claim 18, wherein when the current block is a boundary block, the partition indicator of the non-boundary block partition syntax indicates that the boundary partition is to be performed on the current block.

20. The decoder or encoder of claim 18, wherein when the current block is not a boundary block, the partition indicator in the non-boundary block partition syntax indicates that the current block is not to be split.
